(19) United States
(12) Patent Application Publication
(10) Pub. No.: US 2010/0145480 A1
(43) Pub. Date: Jun. 10, 2010

(54) INFORMATION RECORDING/REPRODUCING APPARATUS AND INFORMATION RECORDING/REPRODUCING METHOD

(75) Inventor: Hisashi Yoshikawa, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/633,370

(22) Filed: Dec. 8, 2009

(30) Foreign Application Priority Data
Dec. 8, 2008 (JP) 2008-312379

(51) Int. Cl. G05B 11/01

(52) U.S. Cl. 700/19

(57) ABSTRACT

A number of components, a core configured to manage the components, and a client configured to utilize the components in combination are included. The client groups all or some of the components to form a group having a group ID as an identifier, and issues a command to the core with designation of a group ID. The core maintains group management information including a group ID and a list of components included in a group, identifies components included in the group having the group ID, and sends the command to the components identified.

### CROSS-REFERENCE TO RELATED APPLICATION

This application is based upon and claims the benefit of priority from the prior Japanese Patent Application No. 2008-312379 filed in Japan on Dec. 8, 2008, the entire contents of which are incorporated herein by reference.

### BACKGROUND OF THE INVENTION

1. Field of the Invention

The present invention relates to an information recording/reproducing apparatus and an information recording/reproduction method for realizing information recording and reproduction based on components.

2. Description of Related Art

Known apparatuses for recording and/or reproducing information, such as a moving image, include apparatuses that are defined by OpenMAX™, for example (see The Khronos Group Inc., OpenMAX™ Integration Layer Application Programming Interface Specification ver 1.1.2.0 (2008), for instance).

In the apparatus described in the document, a number of functional blocks to realize information recording and reproduction are defined and generated as components, and data communication ports are set up among the generated components. And connections for port communication are made among the components and information is transmitted and received between components by way of connected ports. The components are controlled by a component control section (hereinafter referred to as a client).

In such an apparatus as shown in the aforementioned document, the client and components generally send and receive information via a bus. In addition, since components are defined by function, the client needs to control a number of components in order to execute a certain instruction.

By way of example, to execute an instruction (or a command) for stopping reproduction during playback of a moving image, the client has to control a component that realizes video decoding function, a component that realizes video filtering function, and a component that realizes video rendering function at appropriate times.

For this reason, a conventional information recording/reproducing apparatus requires transmission and reception of control signals between the client and a number of components, which in turn involves a high frequency and/or amount of data communication on buses to lead to a problem of time between start of an instruction request and actual execution of the instruction being long.

In addition, when components have dependence on one another, such as when a number of components connected via ports share a buffer, it is sometimes necessary to suspend start of processing by one component until processing by another component that has dependence on that component is complete.

As an example, if the client is to execute a command for stopping reproduction during playback of a moving image when a component that realizes video decoding function and a component that realizes video filtering function are connected with each other via ports and share a buffer, the component that realizes video decoding function cannot complete processing on the buffer until the component that realizes video filtering function completes processing on the shared buffer or processing by the component that realizes filtering function itself is complete.

Thus, a conventional information recording/reproducing apparatus requires transmission and reception of control signals between the client and a number of components, which in turn involves a high frequency and/or amount of data communication on bases, or when components have dependence on one another, time of one component waiting for completion of processing being performed by another component on which the component has dependence will be involved. Consequently, a conventional information recording/reproducing apparatus has a problem that the time between start of an instruction request and actual execution of the instruction is long.

### BRIEF SUMMARY OF THE INVENTION

An information recording/reproducing apparatus according to an embodiment of the present invention includes a plurality of components configured to perform processing corresponding to functions for realizing recording and reproduction of information; a component management section configured to manage the plurality of components; and a component control section configured to utilize the plurality of components in combination and provide a service, wherein the component control section groups all or some of the plurality of components to form a component group, and issues a control instruction with designation of a particular component group to the component management section, and the component management section maintains group management information in which an identifier capable of identifying the component group and a list of components that are included in the component group are stored, and sends the control instruction to the components included in the component group designated by the component control section.

### BRIEF DESCRIPTION OF THE DRAWINGS

FIG. 1 is a schematic block diagram illustrating an example of hardware configuration of an information recording/reproducing apparatus according to an embodiment of the present invention;

FIG. 2 is a schematic block diagram illustrating an example of software configuration of the information recording/reproducing apparatus according to the embodiment of the present invention;

FIG. 3A is a diagram showing an example of group management information 21;

FIG. 3B is a diagram showing an example of command conversion information 23;

FIG. 4 is a flowchart illustrating a sequential flow of processing a command issued by a client; and

FIG. 5 is an activity diagram illustrating a sequential flow of processing a command issued by the client.

### DETAILED DESCRIPTION OF THE EMBODIMENT OF THE INVENTION

An embodiment of the present invention will be described below with reference to drawings.

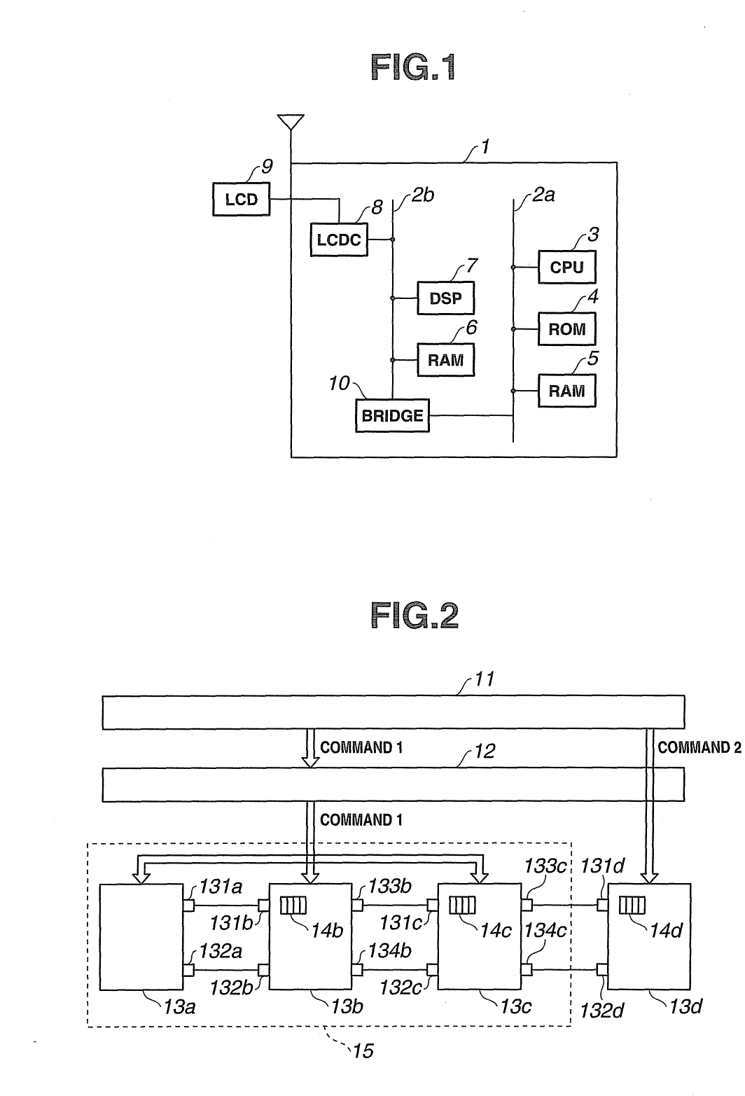

First, referring to FIGS. 1 and 2, configuration of an information recording/reproducing apparatus according to an embodiment of the invention is described. FIG. 1 is a schematic block diagram illustrating an example of hardware configuration of an information recording/reproducing apparatus according to an embodiment of the invention, and FIG. 2 is a schematic block diagram illustrating an example of software configuration of the information recording/reproducing apparatus according to the embodiment of the invention.

The information recording/reproducing apparatus of the embodiment is applicable to apparatuses that realize information recording and reproducing functions on the basis of components in general, such as apparatuses defined by OpenMAX™, and may be applied to information appliances like mobile phones, televisions, or Blu-ray devices, for example. Herein, configuration is described taking a mobile phone with moving image reproducing functions as an example. The present embodiment is also applicable to an information recording apparatus or an information reproducing apparatus in addition to an apparatus that has both information recording and reproducing functions.

As shown in FIG. 1, an information recording/reproducing apparatus 1 of the present embodiment has two lines of buses, a bus 2a and a bus 2b, which are connected with each other via a bridge 10. To the bus 2a, a CPU 3, a ROM 4 in which static execution programs and the like are written, and a RAM 5 configured to store data and the like are connected. To the bus 2b, a RAM 6 configured to store data and the like, a DSP 7 configured to perform audio and/or image processing, and an LCDC (LCD Controller) 8 as a display control section configured to display an image display result or the like on a display device to be discussed below, are connected. The LCDC 8 can be connected to an LCD 9 which is an external display device.

The software configuration of the information recording/reproducing apparatus 1 according to the present embodiment is mainly composed of a client 11 as a component control section configured to issue instructions for recording or reproducing a moving image as commands, components 13a to 13d which are blocks serving as functional units for realizing moving image recording and reproducing functions, and a core 12 as a component management section configured to handle requests from the client 11 and passes the requests to the components 13a to 13d, as shown in FIG. 2.

The components 13a to 13d are provided with ports as connection points for communicating data with other components. In the example shown in FIG. 2, the component 13a is provided with two ports 131a and 132a, and the component 13b is provided with four ports 131b, 132b, 133b and 134b. The component 13c is provided with four ports, 131c, 132c, 133c and 134c, and the component 13d is provided with two ports 131d and 132d.

A component can send and receive data to and from another component by connecting a port provided for itself to a port provided for the other component. For example, the components 13a and 13b have their ports 131a and 131b, and 132a and 132b connected with each other, and can send and receive data to and from each other through these ports.

Similarly, the components 13b and 13c have their ports 133b and 131c, and ports 134b and 132c connected with each other, and can send and receive data to and from each other through these ports. Furthermore, the components 13c and 13d have their ports 133c and 131d, and ports 134c and 132d connected with each other, and can send and receive data to and from each other through these ports.

A port has a buffer as a storage section for temporarily storing data that is sent and received through the port. A buffer is shared between a port at which the buffer is positioned and a port that is connected to the port.

In the example shown in FIG. 2, the port 131b has a buffer 14b, which is shared between the port 131b and the port 131a of the component 13a which is connected to the port 131b. The port 131c has a buffer 14c, which is shared between the port 131c and the port 133b of the component 13b which is connected to the port 131c. Further, the port 131d has a buffer 14d, which is shared between the port 131d and the port 133c of the component 13c which is connected to the port 131d.

The client 11 generates components in accordance with a function that should be realized, predefines arrangement and connection of the components, and groups a number of components as necessary. For example, in FIG. 2, the client 11 generates four components 13a through 13d, and connects the component 13a with the component 13b, the component 13b with the component 13c, and the component 13c with the component 13d using appropriate ports. The client 11 further groups three components 13a, 13b and 13c to establish a component group 15.

Correspondence between the hardware components shown in FIG. 1 and the software components shown in FIG. 2 is as follows. The client 11 is implemented in the RAM 5 and the components 13a to 13d are implemented in the RAM 6. A client-side interface of the core 12 is implemented in the RAM 5 and a component-side interface thereof is implemented in the RAM 6.

Information about the component group 15 grouped by the client 11 is passed from the client 11 to the core 12 to be maintained in the core 12.

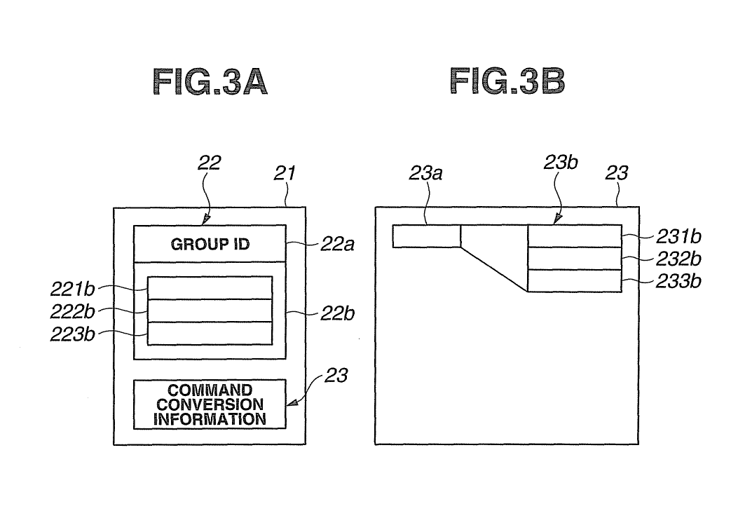

Information about the component group 15 maintained in the core 12 (hereinafter referred to as group management information 21) and command conversion information 23 to be discussed below will be described using FIGS. 3A and 3B, respectively. FIG. 3A is a diagram showing an example of the group management information 21, and FIG. 3B is a diagram showing an example of the command conversion information 23.

As shown in FIG. 3A, the group management information 21 is mainly made up of information about components that belong to a group (hereinafter group information 22) and the command conversion information 23.

The group information 22 is composed of a group ID 22a which is an identifier for identifying a group, and a handle information 22b for components that are included in the group having the group ID. The handle information 22b is information that can locate components, such as a list of pointers to the components included in the group, for example. When three components 13a, 13b and 13c are included in the component group 15 as shown in FIG. 2, for example, a pointer 221b to the component 13a, a pointer 222b to the component 13b, and a pointer 223b to the component 13c are maintained in the form of a list as the handle information 22b.

The command conversion information 23 is information that is used when the core 12 sends a command issued from the client 11 after converting the command to commands corresponding to individual components rather than sending the issued command as it is. More specifically, as shown in FIG. 3B, the command conversion information 23 is maintained such that a received command 23a which is issued from the client 11 to the core 12 is associated with transmission commands 23b which should be sent to the individual components of the group when the command 23a is received, for example.

For example, when three components, 13a, 13b and 13c, are included in the component group 15 as shown in FIG. 2, three transmission commands 23b, i.e., a transmission command 231b to be sent to the component 13a, a transmission command 232b to be sent to the component 13b, and a transmission command 233b to be sent to the component 13c, are maintained as the transmission commands 23b being associated with the one received command 23a.

A specific example of the command conversion information 23 is shown. For example, consider a case where the component 13a is composed of a functional block that realizes video decoding function, the component 13b is of a functional block that realizes video filtering function, and the component 13c is of a functional block that realizes video rendering function, and the three components 13a, 13b and 13c are grouped into the component group 15 as components for realizing video functions.

When a command “create a digest” (a sequence of functions to extract partial images (still images) from a moving image currently being reproduced and connect the images to create a new moving image) is issued to the component group 15 from the client 11, the component 13a carries out reproduction functions, the component 13b carries out the function of extracting and connecting partial images, and the component 13c keeps a halt condition without performing output to a monitor or the like.

In the aforementioned case, “create a digest” is registered as the received command 23a in the command conversion information 23, and as the corresponding transmission commands 23b, “reproduce” is registered in the transmission command 231b, “extract and combine partial images” is in the transmission command 232b, and “stop” (to just inform the client 11 without output to the monitor) is in the transmission command 233b in advance.

With the command conversion information 23 registered in such a manner, when the command “create a digest” is issued from the client 11 to the core 12, the core 12 sends the command “reproduce” to the component 13a, the command “extract and combine partial images” to the component 13b, and the command “stop” to the component 13c.

The components 13a to 13c realize functions in accordance with the respective commands the components received (i.e., the commands converted by the core 12). If the same command “create a digest” is sent to the components 13a to 13c without being converted, the components 13a to 13c need to break down the command into functions that the components each should realize by themselves. On the other hand, when command conversion is performed in the core 12, processing in the components 13a to 13c is simplified because commands adapted to the respective functions to be realized by the components 13a to 13c are sent to the components.

The command conversion information 23 is typically preset in the ROM 4 or the like. The core 12 obtains necessary information from the ROM 4 when generating the group management information 21. When a command issued by the client 11 is sent to the components 13a to 13c as it is without being converted, it is unnecessary to establish the command conversion information 23 and only the group information 22 is stored as the group management information 21.

A group may include another group that is composed of a number of other components. When groups are nested and a group includes another group (hereinafter a “sub-group”), the handle information 22b of the group information 22 can be composed of pointers to the components included in the group and information identifying the sub-group that is included in the same group.

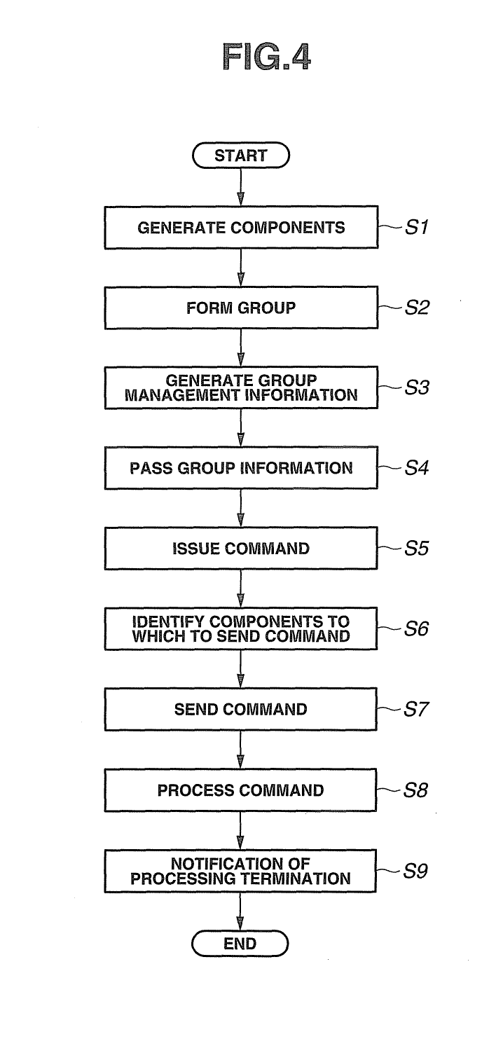

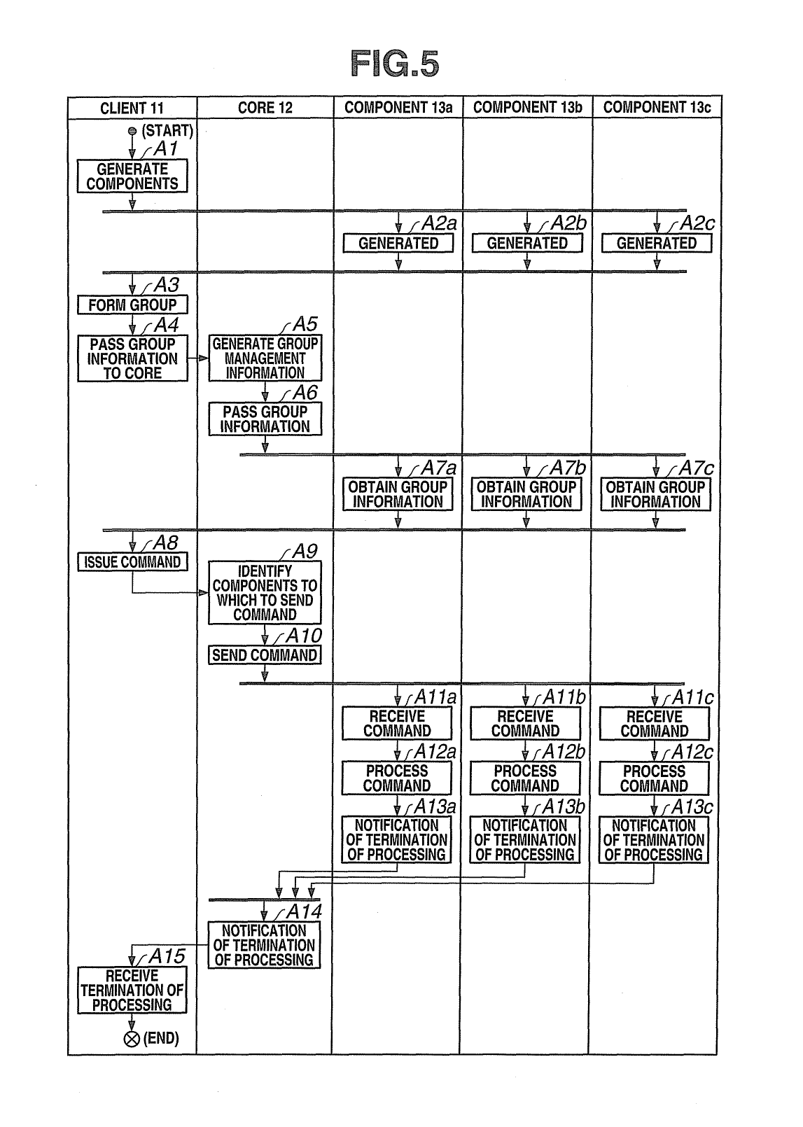

A sequential flow from issuance of a command from the client to processing by components in the information recording/reproducing apparatus configured as shown above will be described using FIG. 4. FIG. 4 is a flowchart illustrating a sequential flow of processing a command issued by the client.

As shown in FIG. 4, the client 11 first generates the components 13a to 13d in accordance with a function that should be realized, and makes arrangement and connection settings of the components (step S1). Then, the client 11 selects components that will operate in cooperation for realizing the function and groups the components (step S2). In the example shown in FIG. 2, three components 13a, 13b and 13c are grouped into the component group 15 in this step.

Connections among the components performed in step S1 may also be made in step S2. In that case, configuration and/or port connection within the component group 15 may be automatically set up rather than being performed in response to an instruction from the client 11. Information on the grouped components is passed from the client 11 to the core 12.

Then in step S3, the core 12 generates the group management information 21 based on the information passed from the client 11. The group management information 21 includes at least group information 22 that is made up of the group ID 22a identifying the group and the handle information 22b that identifies the components belonging to the group.

The generated group management information 21 is passed to the components 13a, 13b and 13c that belong to the component group 15 in the next step S4. The components 13a, 13b and 13c can each identify the other components that belong to the same component group as itself by obtaining the group management information 21. The procedure from step S1 to step S4 described above is steps carried out before a specific function is realized and may be performed during initial setting which is performed soon after the information recording/reproducing apparatus is started up, for example.

Next, in step S5, a command is issued by the client 11 to the core 12. At this point, the group ID 22a of the component group 15 that will be made to execute the command is specified with the command. In the following step S6, the core 12 searches for a component group 15 that has the group ID 22a specified in step S5 from the group management information 21 the core 12 maintains, and identifies the components 13a to 13c that are included in the group (i.e., obtains pointers to the components 13a through 13c).

The core 12 sends the command issued by the client 11 in step S5 to the components 13a to 13c identified (step S7). At this point, if the command conversion information 23 of the group management information 21 is stored and the command issued by the client in step S5 is registered as the received command 23a, the command is converted according to the command conversion information 23 and converted transmission commands 231b to 233b are sent to the components 13a to 13c, respectively.

A conventional information recording/reproducing apparatus requires the client 11 to issue a command via the core 12 to each of components 13a to 13c that are necessary for executing the command. That is to say, to issue a command to the three components 13a to 13c, the core 12 needs to issue the command three times and the same data (i.e., the command) is communicated on the buses 2a and 2b three times.

Especially in a hardware configuration that has the client 11 and the components 13a to 13c operate on separate CPUs by using an accelerator or the like, typified by a case where the client 11 and the components 13a to 13c are connected to the separate buses 2a and 2b via the bridge 10 such as shown in FIG. 1, communication between the client 11 and the components 13a to 13c is low-speed communication performed across the buses 2a and 2b.

Consequently, a conventional information recording/reproducing apparatus involves a large number of data communications as well as a long communication time, causing a problem that a time lag occurs between when a command is issued from the client 11 to the components 13a to 13c and when the command is executed. That is, the problem is that, by way of example, when “pause” is to be effected during playback of a moving image, a delay occurs between when the client 11 issues a “pause” command and when the moving image actually stops, and an image that the user wants to display on the monitor as a still image is different from an image that is actually displayed on the monitor as a still image, significantly hampering the user's convenience.

On the other hand, the information recording/reproducing apparatus of the present embodiment requires the client 11 only to specify the component group 15 to the core 12 and issue a command once as mentioned above (step S7). In addition, since the client 11 and the client-side interface of the core 12 are implemented in the same RAM 5 and the component-side interface of the core 12 and the components 13a to 13c are implemented in the same RAM 6, communication can be performed at a high speed as opposed to low-speed communication across buses as in a conventional apparatus. Consequently, the frequency and amount of data communication can be reduced and communication time can be shortened.

In step S8, the components 13a to 13c process the command received from the core 12. At this point, the components 13a to 13c each have already obtained information about the other components belonging to the same component group 15 in step S4. Thus, each of the components 13a to 13c checks connection between the other components belonging to the same component group 15 as itself and its own port before processing the command.

When a component's port is connected with another component of the same component group 15 and the two components share a buffer, the component can perform its own buffer processing without having to consider buffer processing by the other component even when a command for controlling buffer processing, e.g., “stop”, is issued to the entire component group 15 to which the component belongs. In other words, the components 13a to 13c belonging to the component group 15 can process the command in parallel without having to wait for completion of command processing being performed by the other components and therefore processing time can be shortened.

When command processing in step S8 is complete, the flow proceeds to step S9, where the client 11 is notified that processing has terminated by the components 13a through 13c via the core 12. Notification of termination of processing from the core 12 to the client 11 may be made each time a component provides a notification to the core 12 or may be performed only once in a batch after notifications from all components that have processed the command are received. Through performance of the steps S1 to S9, processing of the command issued by the client 11 is completed.

To issue a command to the component 13d which is not included in the component group 15, the command is directly issued to the component 13d from the client 11 via the core 12 as in conventionally.

Processing of a command issued from the client will be further described using a specific example. Here, description is given by using the activity diagram of FIG. 5 and illustrating a case where the component 13a is composed of a functional block that realizes video decoding function, the component 13b is of a functional block that realizes video filtering function, and the component 13c is of a functional block that realizes video rendering function, the three components 13a, 13b and 13c being grouped into the component group 15 as components that realize video functions, and a command “stop playback” is issued from the client during reproduction of a moving image.

FIG. 5 is an activity diagram illustrating a sequential flow of processing a command issued from the client. First, in activity A1, the client 11 generates the component 13a as a functional block that realizes video decoding function, the component 13b as a functional block that realizes video filtering function, and the component 13c as a functional block that realizes video rendering function, and makes arrangement and connection settings. In response to activity A1, the components 13a to 13c are generated at the same time (activities A2a, A2b and A2c). Activities A1, and A2a to A2c correspond to step S1 of FIG. 4.

Upon completion of all the activities A2a, A2b and A2c, the client 11 selects components 13a, 13b and 13c that will operate in cooperation to realize video functions, and groups the components as the component group 15 (activity A3). The client 11 then provides the core 12 with information about the component group 15 formed. Activities A3 and A4 correspond to step S2 of FIG. 4.

Upon receiving the information about the component group 15 from the client 11 through execution of activity A4, the core 12 generates the group management information 21 based on the information (activity A5).

The group management information 21 includes group information 22 that is composed of the group ID 22a identifying the component group 15 and the handle information 22b identifying components 13a to 13c included in the group. Here, the handle information 22b is made up of the pointer 221b to the component 13a, the pointer 222b to the component 13b, and the pointer 223b to the component 13c.

The core 12 also obtains the command conversion information 23 relating to the component group 15 from the ROM 4 and stores the information 23 in the group management information 21. It is assumed that conversion information for the “stop playback” command issued by the client 11 is not registered in the ROM 4. The activity AS corresponds to step S3 of FIG. 4.

The core 12 then passes the group management information 21 about the generated component group 15 to the components 13a to 13c belonging to the same group (activity A6). In response to activity A6, the components 13a to 13c obtain the group management information 21 at the same time (activities A7a, A7b and A7c). This activity enables the components 13a to 13c to each recognize the other components belonging to the same group. The activities A6 and A7a through A7c correspond to step S4 of FIG. 4.

When all of the activities A7a, A7b and A7c are complete, a “stop playback” command is issued from the client 11 to the core 12 (activity A8). At this point, the group ID 22a of the component group 15 which will be made to execute the command is specified with the command.

Then, in activity A9, the core 12 searches for a component group 15 that has the group ID 22a specified in activity A8 from the group management information 21 the core 12 maintains, and identifies the components 13a to 13c that are included in the group (i.e., obtains pointers to the components 13a to 13c). If converted commands for the “stop playback” command are registered in the command conversion information 23 of the group management information 21, the core 12 obtains commands to be sent to the components 13a to 13c.

The core 12 sends the “stop playback” command issued by the client 11 in activity A8 to the components 13a to 13c identified (activity A10). The activities A8, A9 and A10 correspond to steps S5, S6 and S7 of FIG. 4, respectively.

In response to activity A10, the components 13a to 13c receive the “stop playback” command from the core 12 at the same time (activities A11a, A11b, and A11c).

Before processing the command, the component 13a has obtained the group management information 21 in activity A7a and recognizes that the components 13b and 13c belong to the same component group 15 as itself. The component 13a also checks the ports that the component 13a manages to recognize that the port 131a is connected with the port 131b of the component 13b and the port 132a is connected with the port 132b of the component 13b. The component 13a also recognizes that the component 13a shares the buffer 14b with the component 13b.

A conventional information recording/reproducing apparatus generally performs processing during reproduction of a moving image in the following manner. First, data is processed in a functional block that realizes decoding function (i.e., the component 13a) and processed data is input to the port 131b by way of the port 131a. The data input to the port 131b is processed in a functional block that realizes video filtering function (i.e., the component 13b), and the processed data is output to a functional block that realizes video rendering function (i.e., the component 13c) from the port 133b via the port 131c.

To effect “stop playback” in this state (i.e., during reproduction of a moving image), the “stop playback” command is issued to each of the components 13a and 13b from the client 11. In a configuration in which the components 13a and 13b achieve synchronization through the ports 131a and 131b while performing a handshake and update the buffer 14b, the component 13a has to make sure either that “stop playback” processing by the component 13b has been complete or that the component 13b has completed processing on the buffer 14b which is shared at the port 131a before terminating its own “stop playback” processing.

Furthermore, in a configuration in which the component 13b also achieves synchronization with the component 13c through ports while performing a handshake and updates the buffer 14c, the component 13b has to make sure that “stop playback” processing by the component 13c has been complete or the component 13c has completed processing on the buffer 14c which is shared at the port 133b before terminating its own “stop playback” processing. That is to say, in a configuration that connects a number of components in a row, the greater the number of connected stages, the longer time will be required between when the client 11 issues the “stop playback” command and when the components 13a to 13c complete “stop playback” processing.

On the other hand, in the information recording/reproducing apparatus of the present embodiment, when the component 13a has received the “stop playback” command, the component 13a is aware that the “stop playback” command has also been sent to the other components 13b and 13c which belong to the same component group 15 as itself. Therefore, the component 13a can start and complete its own “stop playback” processing without having to wait for completion of “stop playback” processing of the component 13b on which the component 13a has dependence (activity A12a). The components 13b and 13c similarly can start and complete their own “stop playback” processing without having to wait for completion of processing by the other components that belong to the same component group 15 as themselves and on which the components 13b and 13c have dependence (activities A12b and A12c).

In this case, “stop playback” processing by the component 13a may cause inconsistency in data stored in the buffer 14b which is shared between the components 13a and 13b. However, since the component 13b also is performing “stop playback” processing and is known not to perform processing on the buffer 14b, there will be no problem if inconsistency occurs. The same applies to the buffer 14c.

As described above, since the information recording/reproducing apparatus of the present embodiment permits parallel command processing even when the multiple components 13a to 13c belonging to the same component group 15 have dependence on one another, such as when they connect their ports with each other and share buffers, processing can be completed in a small amount of time after a command is received. The activities A11a to A11c, and A12a to A12c correspond to step S8 of FIG. 4.

Upon completing “stop playback” processing, the components 13a to 13c each notify the core 12 of termination of processing (activities A13a, A13b and A13c). Having received notifications that processing has terminated from all of the components 13a to 13c, the core 12 informs the client 11 that “stop playback” processing by all the components has finished (activity A14).

By the client 11 receiving a notification that “stop playback” processing has terminated from the core 12, processing of the “stop playback” command is complete (activity A15). The activities A13a to A13c, A14 and A15 correspond to step S9 of FIG. 4.

As described above, since the present embodiment of the invention has a configuration in which the components 13a to 13c are grouped in advance and the core 12 manages the component group 15, the client 11 has to issue a command only once to the core 12 even when issuing a command for performing processing using the multiple components 13a to 13c. Therefore, the frequency and/or amount of data communications can be reduced.

In addition, efficiency of processing can be improved and processing can be completed within a short time after a command is issued because the components 13a to 13c belonging to the same component group 15 can process a command in parallel even when they have dependence on each other, such as connecting their respective ports with each other and sharing a buffer. The present embodiment can improve efficiency of processing performed by components that have dependence on one another and shorten the time between start of an instruction request and actual execution of the instruction.

The present invention is not intended to be limited to the above-described embodiment and various modifications or variations can be made without departing from the scope of the invention.

What is claimed is:

1. An information recording/reproducing apparatus, comprising:
a plurality of components configured to perform processing corresponding to functions for realizing recording and reproduction of information;
a component management section configured to manage the plurality of components; and
a component control section configured to utilize the plurality of components in combination and provide a service, wherein
the component control section groups all or some of the plurality of components to form a component group, and issues a control instruction with designation of a particular component group to the component management section, and
the component management section maintains group management information in which an identifier capable of identifying the component group and a list of components that are included in the component group are stored, and sends the control instruction to the components included in the component group designated by the component control section.

2. The information recording/reproducing apparatus according to claim 1, wherein the component management section further maintains control instruction conversion information that associates the control instruction issued to the component group with a plurality of component control instructions to be respectively sent to the plurality of components included in the component group, converts the control instruction issued by the component control section into the component control instructions based on the instruction conversion information, and respectively sends the component control instructions to the plurality of components.

3. The information recording/reproducing apparatus according to claim 1, wherein upon receiving a notification to the component control section from the plurality of components included in the component group, the component management section converts the notification into a group notification from the component group to the component control section, and sends the group notification to the component control section.

4. The information recording/reproducing apparatus according to claim 1, wherein each one of the components identifies other components included in the component group to which the component belongs, extracts connections and dependence relations between the other components and the component itself, and when a particular control instruction to the component group is issued, performs processing with a change to a control method used with the other components.

5. The information recording/reproducing apparatus according to claim 4, wherein the components perform processing in parallel with no regard to dependence relations with the other components when the particular control instruction is issued.

6. The information recording/reproducing apparatus according to claim 5, wherein the components notify the component control section that processing has terminated via the component management section when the processing is complete.

7. The information recording/reproducing apparatus according to claim 1, wherein the group management information has pointers to the components included in the component group.

8. The information recording/reproducing apparatus according to claim 1, wherein
each of the plurality of components has one or more connection points, and
each one of the components connects the connection point provided for the component with the connection point provided for another component included in the component group to which the component belongs, and sends and receives data to and from the other component which has been connected.

9. The information recording/reproducing apparatus according to claim 8, wherein the components comprise storage sections for temporarily storing the data sent and received to and from the other component connected.

10. An information recording/reproducing apparatus, comprising:
a plurality of components configured to perform processing corresponding to functions for realizing recording and reproduction of information;
a component management section configured to manage the plurality of components;
a component control section configured to utilize the plurality of components in combination and provide a service; and
a display control section configured to display a result of processing by the plurality of components on a display device, wherein
the component control section groups all or some of the plurality of components to faun a component group, and issues a control instruction with designation of a particular component group to the component management section, and
the component management section maintains group management information in which an identifier capable of identifying the component group and a list of components that are included in the component group are stored, and sends the control instruction to the components included in the component group designated by the component control section.

11. The information recording/reproducing apparatus according to claim 10, wherein the component management section further maintains control instruction conversion information that associates the control instruction issued to the component group with a plurality of component control instructions to be respectively sent to the plurality of components included in the component group, converts the control instruction issued by the component control section into the component control instructions based on the instruction conversion information, and respectively sends the component control instructions to the plurality of components.

12. The information recording/reproducing apparatus according to claim 10, wherein upon receiving a notification to the component control section from the plurality of components included in the component group, the component management section converts the notification into a group notification from the component group to the component control section, and sends the group notification to the component control section.

13. The information recording/reproducing apparatus according to claim 10, wherein each one of the components identifies other components included in the component group to which the component belongs, extracts connections and dependence relations between the other components and the component itself, and when a particular control instruction to the component group is issued, performs processing with a change to a control method used with the other components.

14. The information recording/reproducing apparatus according to claim 13, wherein the components perform processing in parallel with no regard to dependence relations with the other components when the particular control instruction is issued.

15. The information recording/reproducing apparatus according to claim 14, wherein the components notify the component control section that processing has terminated via the component management section when the processing is complete.

16. The information recording/reproducing apparatus according to claim 10, wherein the group management information has pointers to the components included in the component group.

17. The information recording/reproducing apparatus according to claim 10, wherein
each of the plurality of components has one or more connection points, and
each one of the components connects the connection point provided for the component with the connection point provided for another component included in the component group to which the component belongs, and sends and receives data to and from the other component which has been connected.

18. The information recording/reproducing apparatus according to claim 17, wherein the components comprise storage sections for temporarily storing the data sent and received to and from the other component connected.

19. An information recording/reproducing method, comprising:
performing, by a plurality of components, processing corresponding to functions for realizing recording and reproduction of information;
managing the plurality of components by a component management section; and
utilizing, by a component control section, components of the plurality of components in combination and providing a service, wherein
the component control section groups all or some of the plurality of components to form a component group, and issues a control instruction with designation of a particular component group to the component management section, and
the component management section maintains group management information in which an identifier capable of identifying the component group and a list of components that are included in the component group are stored, and sends the control instruction to the components included in the component group designated by the component control section.

20. The information recording/reproducing method according to claim 19, wherein the component management section further maintains control instruction conversion information that associates the control instruction issued to the component group with a plurality of component control instructions to be respectively sent to the plurality of components included in the component group, converts the control instruction issued by the component control section into the component control instructions based on the instruction conversion information, and respectively sends the component control instructions to the plurality of components.
